(19) United States
(12) Patent Application Publication
(10) Pub. No.: US 2015/0172416 A1
(43) Pub. Date: Jun. 18, 2015

(54) DOWNLOAD REDIRECTION METHOD AND SYSTEM

(71) Applicant: Shuteit, LLC, Laconia, NH (US)

(72) Inventors: Mikael G. Morancy, Laconia, NH (US); Bradley A. Gagne, Londonderry, NH (US); Ashley Nialetz, Belmont, NH (US); Sean Frost-Brown, Gilford, NH (US)

(21) Appl. No.: 14/568,741

(22) Filed: Dec. 12, 2014

Related U.S. Application Data
(60) Provisional application No. 61/915,725, filed on Dec. 13, 2013.

(51) Int. Cl. H04L 29/08

(52) U.S. Cl. CPC H04L 67/34

(57) ABSTRACT

The download redirection method and system directs the transfer of data from an online source, such as files available on the internet, files attached to email messages and the like, to authenticated cloud storage instead of to the device being used by the user. This redirection involves the download process on the device, such as a dedicated download manager, or function of a browser, email or other such applications, relinquishing control to the present invention, and the transfer of the requested data to the cloud storage provider without the requested file being transferred through the user device to the user's cloud storage provider.

### CLAIM OF PRIORITY

This application claims the benefit of priority of U.S. Provisional Patent Application Ser. No. 61/915,725, filed on Dec. 13, 2013.

### FIELD OF THE INVENTION

The present invention is in the technical field of computer networking. More particularly, the present invention is in the technical field of data transmission.

### BACKGROUND OF THE INVENTION

In the traditional file transfer model, a user with a device is conceptually depicted as being on one plane with online and cloud storage resources above them. The flow of data from the user to online and cloud storage resources conceptually flows up, to upload data to those resources. The opposite is true as well, as data conceptually flowing from online and cloud storage resources down, to download data to the user.

The present invention seeks to modify this model to enable the user with a device to substitute the location that data from online resources downloads to and replace it with the location of the user's authenticated cloud storage account.

### SUMMARY OF THE INVENTION

The present invention is a method and system for downloading online content that bypasses a user device, enabling data to flow from an online source of the online content to a third storage position, such as an authenticated cloud storage account; conceptually creating a lateral movement of requested online content from its online source to the third storage position. As an authenticated cloud storage account is the preferred embodiment of the third storage position, hereinafter, it is understood that references to the “authenticated cloud storage account” are references to the more general “third storage position,” which may be any type of internet storage commonly used in the art, including but not limited to cloud storage. In addition, references to “data” or the “requested file” are understood to refer to the “online content,” discussed above. The device is defined as any commonly known and recognizable instrument containing memory and a data processing device coupled to the memory with the ability to transmit and receive data, including but not limited to smartphones, laptop computers, desktop computers, and tablets. Any applications such as browsers, email clients or other methods of downloading a file that are currently integrated with the device and commonly used in the art may be utilized by the download redirection system.

The system of the present invention includes the user device on which is installed software containing instructions that, when executed, cause the various components of the system to perform the steps of the method of the present invention; the online source of the online content; and the third storage position. Each of the user device, the online source, and the third storage position are in communication with one another through an internet connection. Hereinafter references to “online communication” are understood to mean communication via an internet connection. As discussed in more detail below, in some embodiments, the system also includes an intermediate or proxy server, which is also in online communication with the user device, the online source, and the third storage position through the internet. In some embodiments, the system also includes a second device that is in communication through the internet with at least the third storage position.

It is preferred that the system is controlled through an application installed on the user device, which integrates with the download process and substitutes the traditional storage location on the user device for the location of the user's authenticated cloud storage account. This results in the redirection of the requested file from the user device to the user's authenticated cloud storage account.

The application is a user interface for controlling the system of the present invention, which includes software for performing the method of the present invention. In its most basic form, the method includes the steps of receiving an indication of the online content to be downloaded; directing the download to the third storage position; and downloading the online content to the third storage position. As discussed below, the indication of the online content to be downloaded may come from the user device directly; from the user device indirectly through an intermediate server or the third storage position; or from the online source itself, such as in an automated process, such as application or other content updates. In some embodiments, the first two steps of receiving an indication of the online content to be downloaded and directing the download to the third storage position occur simultaneously. This simultaneous action is commonly referred to as an add-on or plug-in. In another embodiment of this alternative, an intermediary server could be incorporated to relay the requested file to the third storage position.

In preferred embodiments, the step of directing the download to the third storage position includes providing the online source with a uniform resource identifier (URI) of the third storage position. A URI specifies where an identified resource, such as the third storage position, is available and the mechanism for retrieving or accessing that resource. In some embodiments, the step of receiving an indication of the online content to be downloaded includes the steps of providing the third storage position with a URI of the online content desired to be downloaded; and sending a request from the third storage position to the online content source for a transmission of the online content desired to be downloaded.

As mentioned above, in some embodiments of the method, upon initiation of the download of a requested file, an intermediary server is directed to become involved in the download process. The intermediary server may direct the online content source server of the requested file to transmit the requested file to the user's authenticated cloud storage account. In another embodiment of this alternative, the intermediary server may request the requested file be downloaded to itself, and would then relay the requested file to the user's authenticated cloud storage account.

In another embodiment of the method of the present invention, the online content source location of the requested file is relayed to the intermediary server, which in turn relays the online content source location of the requested file to the user's authenticated cloud storage account, which initiates the transfer of the requested file to itself.

In another embodiment of the method of the present invention, the online content source server of the requested file is directed to contact the intermediary server for instructions. The intermediary server will instruct the online content source server to transfer the file to the user's authenticated cloud storage account. In an alternative embodiment, the intermediary server can request the requested file be transmitted to itself and would then relay it to the user's authenticated cloud storage account. In some embodiments involving an intermediary server, the intermediary server acts as a proxy for the user device, and handles the redirection of the requested file. The user device connects to the intermediary server which would then identify the requested file on the user's behalf. The intermediary server will provide the requested file's source online content server with the location of the user's authenticated cloud storage account. In another embodiment of this alternative, the intermediary server can request the requested file be transmitted to itself and would then relay it to the user's authenticated cloud storage account.

Generally speaking, for all of the above embodiments, an online source presents a file to the user device. This may be at the request of the user or an automated process outside of the user's control. The online source can be any manner of files from internet sources, files attached to email, and the like. The user device's own method of downloading the requested data relinquishes control to the download redirection system.

The download redirection system may act in a number of different ways depending on the embodiment of the method being executed by the system. Actions taken by the download redirection system all involve communication with the online content source, the user's cloud storage provider, and may necessitate the involvement of an intermediary server to relay credentials or the requested file. Transmissions to coordinate authentication and data transfer requests between the user device, the online source of the requested file, the user's cloud service provider, and an intermediary server take many forms, and information may travel in different directions between the various system components, but the end result is the same: The requested file does not get transferred to the user device, but rather to the user's cloud storage account.

### BRIEF DESCRIPTION OF THE DRAWING

FIG. 1 is a schematic block diagram of the traditional download and upload model.

FIG. 2 is a schematic block diagram of the basic method of the present invention, which is the traditional download and upload model with modifications.

FIG. 3 is a schematic block diagram of the download redirection method and system.

FIG. 4 is a schematic block diagram of an alternate embodiment wherein the online content server receives the location to transmit the requested file to authenticated cloud storage.

FIG. 5 is a schematic block diagram of an alternate embodiment wherein the cloud storage provider requests the requested file.

FIG. 6 is a schematic block diagram of an alternate embodiment wherein the download redirection of a requested file occurs simultaneously with its identification with or without the assistance of an intermediary server.

FIG. 7 is a schematic block diagram of an alternate embodiment with an intermediary server transmitting cloud storage provider credentials with or without the assistance of the intermediary server relaying the requested file.

FIG. 8 is a schematic block diagram of an alternate embodiment with an intermediary server relaying user credentials and location of a requested file to a cloud storage provider.

FIG. 9 is a schematic block diagram of an alternate embodiment wherein the user device directs the online content server to contact an intermediary server which will either direct the online content server to download to an authenticated cloud storage or to download to the intermediary server which in turn will relay to authenticated cloud storage.

FIG. 10 is a schematic block diagram of an alternate embodiment where an intermediary server acts as a proxy for the user device.

### DETAILED DESCRIPTION

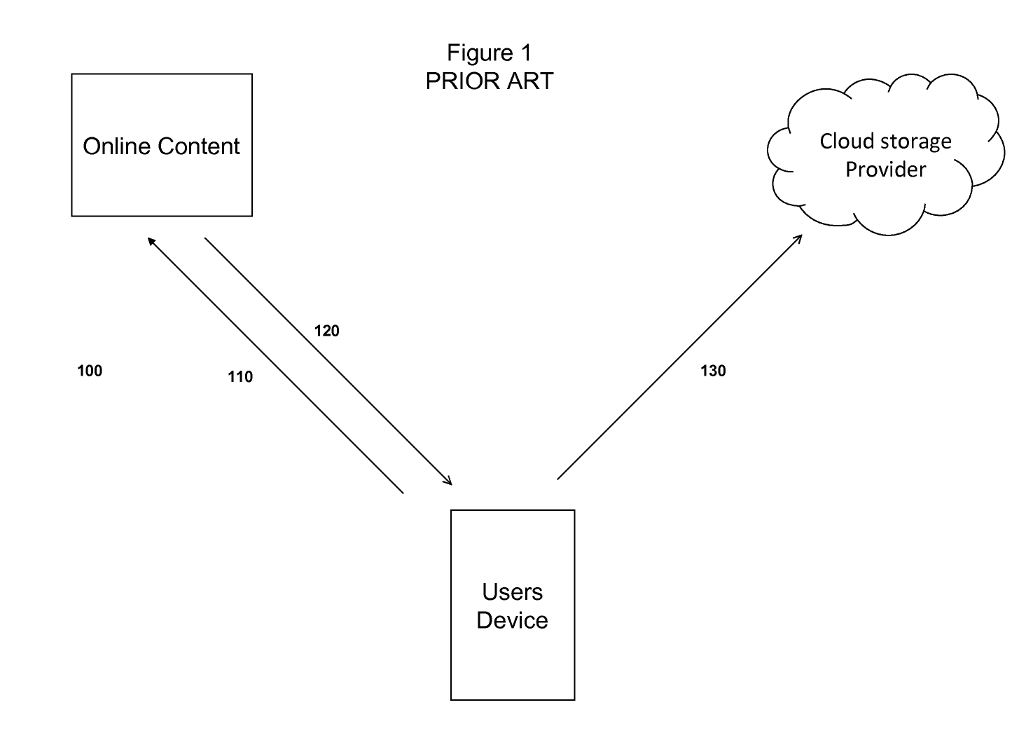

Referring first to FIG. 1, a schematic block diagram illustrating a prior art conventional download and upload model is provided. As shown in FIG. 1, the user identifies a requested file from an online content source 110. This may be a file of any type or description that is made available by a web site or attached to an email. The user device downloads the requested file 120 and saves it to a location with a specific URI within the user device. The user utilizes an application or other means provided by her cloud storage provider to upload 130 the requested file to storage. Once within cloud storage, the requested file is available from any accessible means.

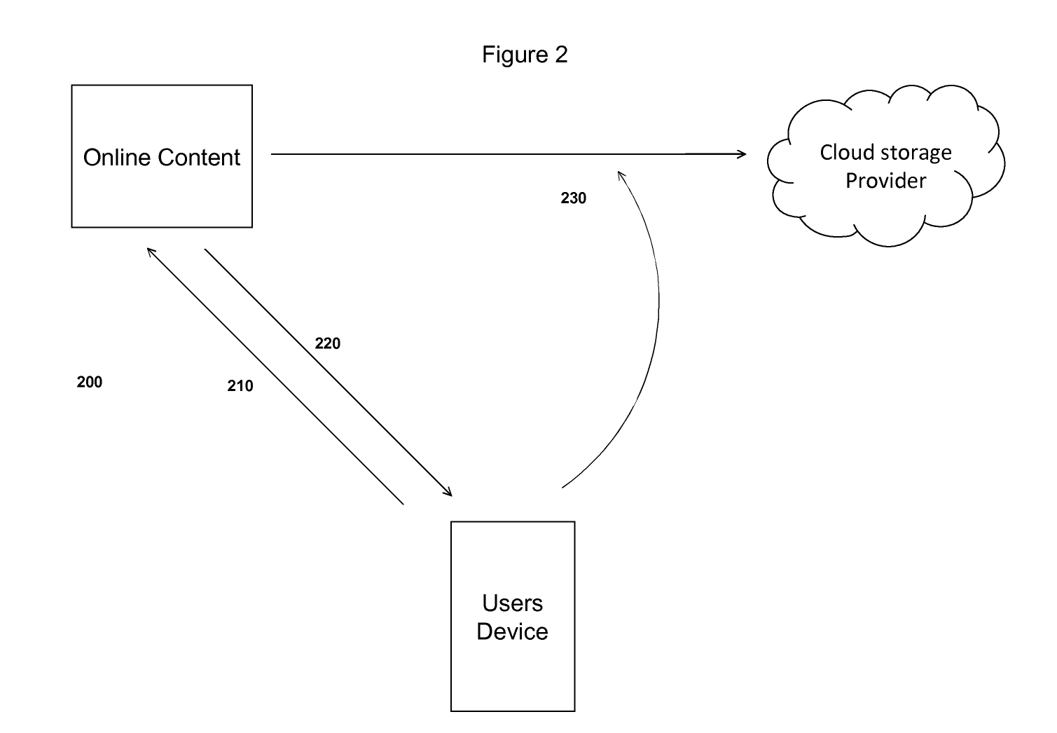

Now referring to FIG. 2, a schematic block diagram of the basic method of the present invention is provided. The user identifies a requested file from online content, which is step 210: receiving an indication of the online content to be downloaded. This step initiates a download of the requested file. The present invention intervenes in the process of downloading the requested file from its online content location, which is step 220: directing the download to the third storage position. The download is thus directed away from the user device to an authenticated cloud storage account, which is step 230: downloading the online content to the third storage position. It is preferred that step 220 of directing the download to the third storage position is achieved by providing the online source with a third storage position URI, which effectively replaces the URI of the location where files are downloaded to on the user device with the URI of the authenticated cloud storage account.

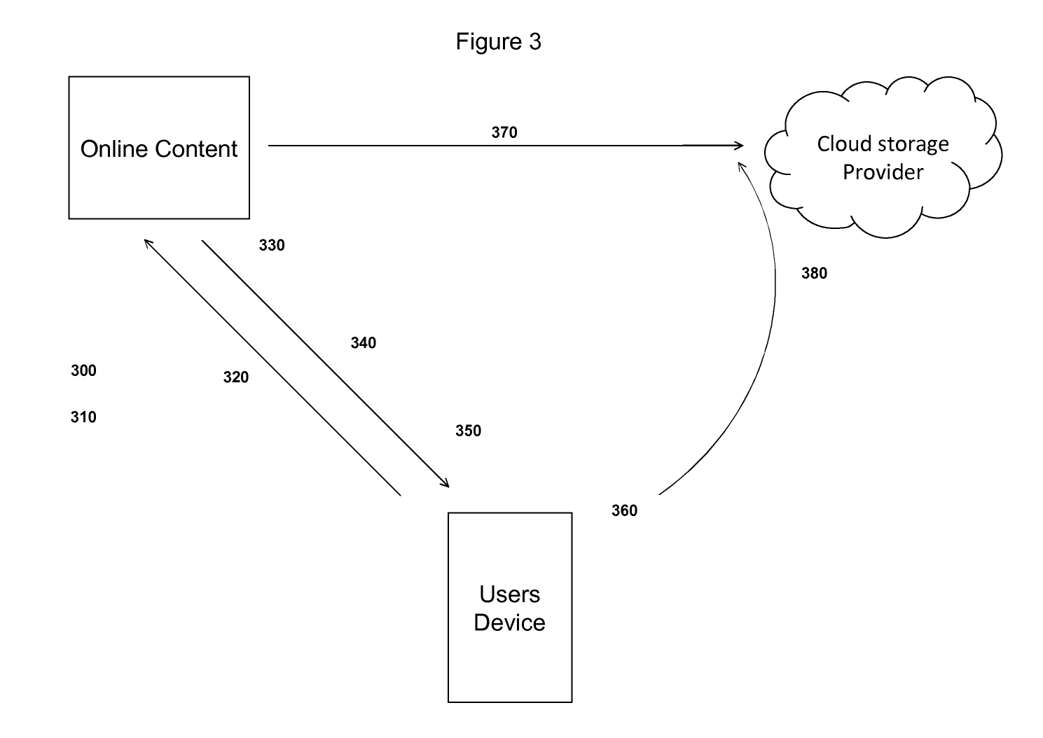

Now referring to FIG. 3, the preferred embodiment of the download redirection method and system is provided. FIG. 3 is a schematic block diagram of the detail of the present invention. It is understood that the user downloads and installs the download redirection system on their device 300 through established means such as from a web site or service specific to their device. Part of the setup of installing the system on the user device includes step 310: configuring the user device with credentials for authentication allowing access to the third storage position. The credentials for authentication will grant the user access to authenticated cloud storage. The download redirection system retains this information in a secure manner. When the user wishes to redirect the download of a requested file to authenticated cloud storage, the download redirection system will call upon this securely stored credential to submit to authenticated cloud storage and direct the download of the requested file. In step 320, receiving an indication of the online content to be downloaded, the user identifies the requested file. This indication may be by a browser, email client, or other commonly used internet applications. The indication is preferably performed by receiving not only an indication of the online content to be downloaded, but also the user device URI. Upon locating the requested file, the user initiates a download of the requested file 330. The download redirection system is activated and intervenes with the download of the requested data. At this point it is preferred that steps 340: transmitting the credentials for authentication via a third storage position application programming interface (API); and 350: of loading the drive state of the third storage position API to prepare the third storage position to receive the online content. In other words, the download redirection system transmits cloud storage provider credentials entered at for authentication by way of the cloud storage provider's API. With the credentials authenticated, the download redirection system loads the drive state of the cloud service provider's API to prepare to receive the requested file download. The major cloud storage providers and other companies that have products and services that integrate with online applications provide APIs to allow those applications the ability to access the product or service. The APIs handle the authentication and routing of data into the provider's product or service so that application developers may focus on their goals and their side of the code. In short, the APIs write and provide half of the code necessary to get a task accomplished.

In step 360, the general step of directing the download to the third storage position is performed by replacing the user device URI with a third storage position URI to redirect the download from the user device to the third storage position. In step 370: downloading the online content to the third storage position, the download to authenticated cloud storage commences with a resumable session to the URI of authenticated cloud storage. Step 380 is sending an acknowledgement to the user device when the step of downloading the online content to the third storage position is completed. Upon completion of the download, the authenticated cloud storage gives an acknowledgment message, which the download redirection system displays in some form to the user, advising that the download of the requested file to authenticated cloud storage has been completed.

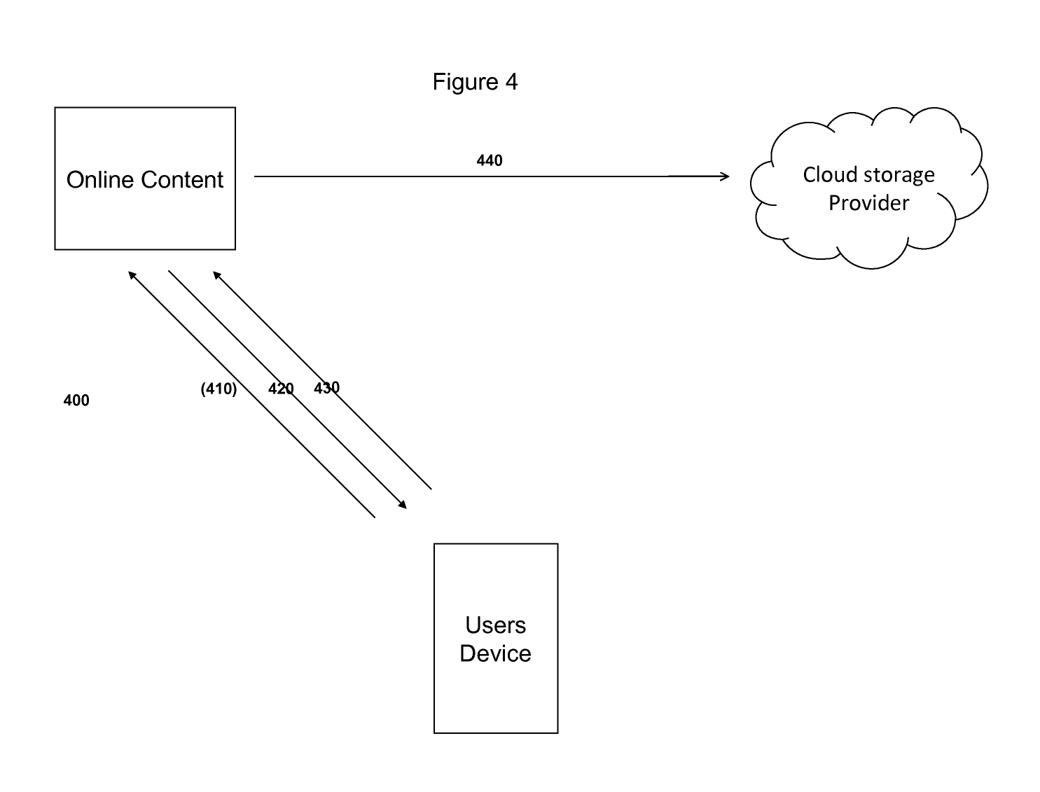

Now referring to FIG. 4, step 410 is an optional step where the step of receiving an indication of the online content to be downloaded comes from the user device. In this case, the user may identify a requested file from an online content source, and initiate a download of the requested file to her device. The online content source seeks user acknowledgment to download the requested file in step 420: receiving a request from the online content source for confirmation of a request to download the online content to the third storage position. It is understood that it is also possible for the online content source to attempt to download a file to the user device without the user's express desire to do so, such as during an automatic process, or update of content, for examples. Step 430 is confirming the request to download the online content to the third storage position by providing the third storage position URI from the user device to the online content source. This is a specific example of the more general step of receiving from the user device an indication of the third storage position to which the user has access and to which the user desires the online content to be downloaded. The requested file is downloaded to authenticated cloud storage in step 440.

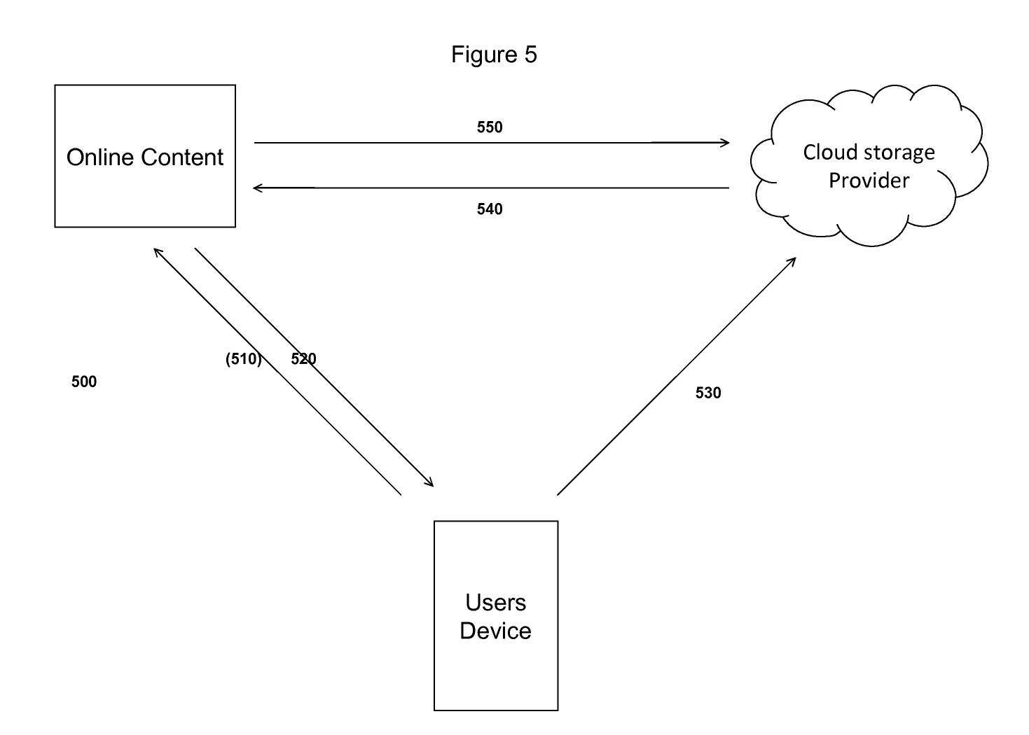

Referring now to FIG. 5, in this alternate method, steps 510 and 520 are as described above with respect to steps 410 and 420 above. These steps involve the steps of receiving a request from the online content source for the third storage position and providing the third storage position to the online content source. The step of providing the third storage position to the online content source may be by providing a default third storage position or a selected third storage position. In other words, when the user first installed and set up the system on her device, she may have chosen a default third storage position at that time and entered it into her settings so that that default third storage position is always provided when the online content source requests the third storage position. Alternatively, the step of providing the third storage position to the online content source may be by receiving a third storage position from the user device that is selected by the user upon the request of the online content source and providing the online content source with that selected third storage position. The present invention authenticates to the cloud storage provider and submits the URI of the requested file to be downloaded in step 530: providing the third storage position with a URI of the online content desired to be downloaded and authenticating the user device to the third storage position. Authenticated cloud storage provider requests the requested file of the online content source in step 540: sending a request from the third storage position to the online content source for a transmission of the online content desired to be downloaded. The online content source transfers the requested file to authenticated cloud storage in step 550.

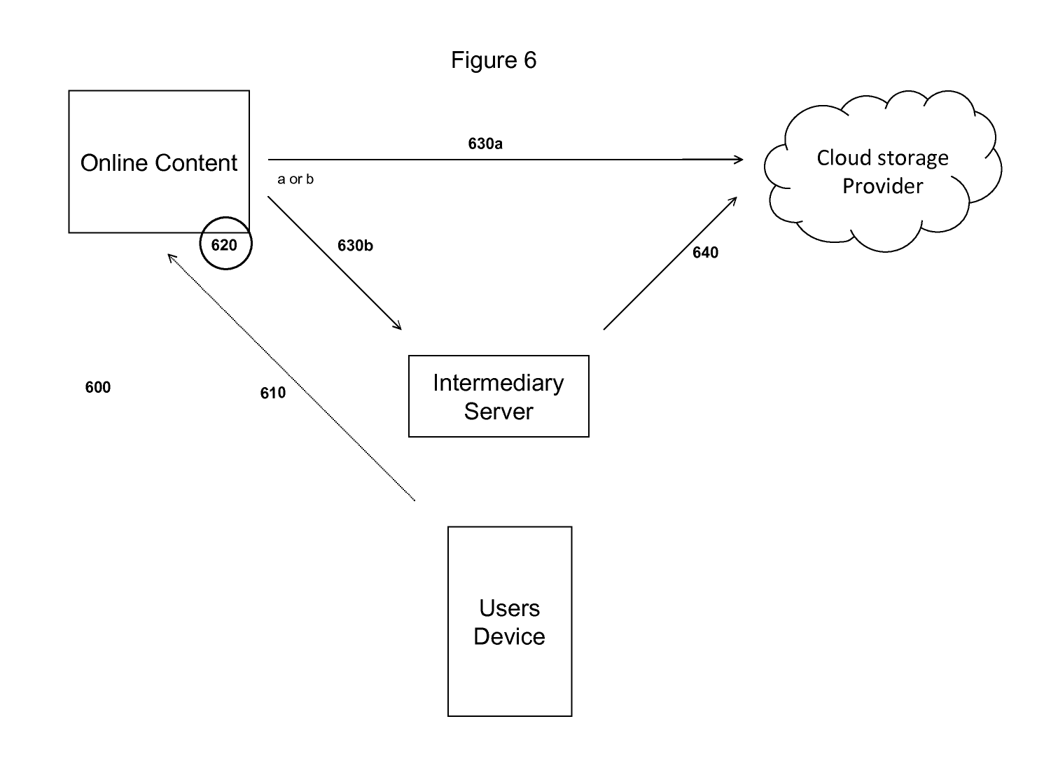

Now referring to FIG. 6, a schematic block diagram of the action of redirecting a download from the user device to authenticated cloud storage by way of a plugin or add on that will instantaneously redirect the file transfer without active user involvement is provided. The user identifies the requested file 610 and the simultaneous action of supplying the URI of either the third storage position or an intermediary server 620 takes place. This action may take one of two forms: The simultaneous action can direct the data transfer of the requested file directly to the authenticated cloud storage account the user has specified 630a, as discussed above with reference to FIGS. 2-5. Alternatively, the simultaneous action can direct the data transfer of the requested file to an intermediary server, which is step 630b: downloading the online content from the online content source to the intermediary server, which will then relay the requested file to the authenticated cloud storage account the user has specified, which is step 640: downloading the online content from the intermediary server to the third storage position.

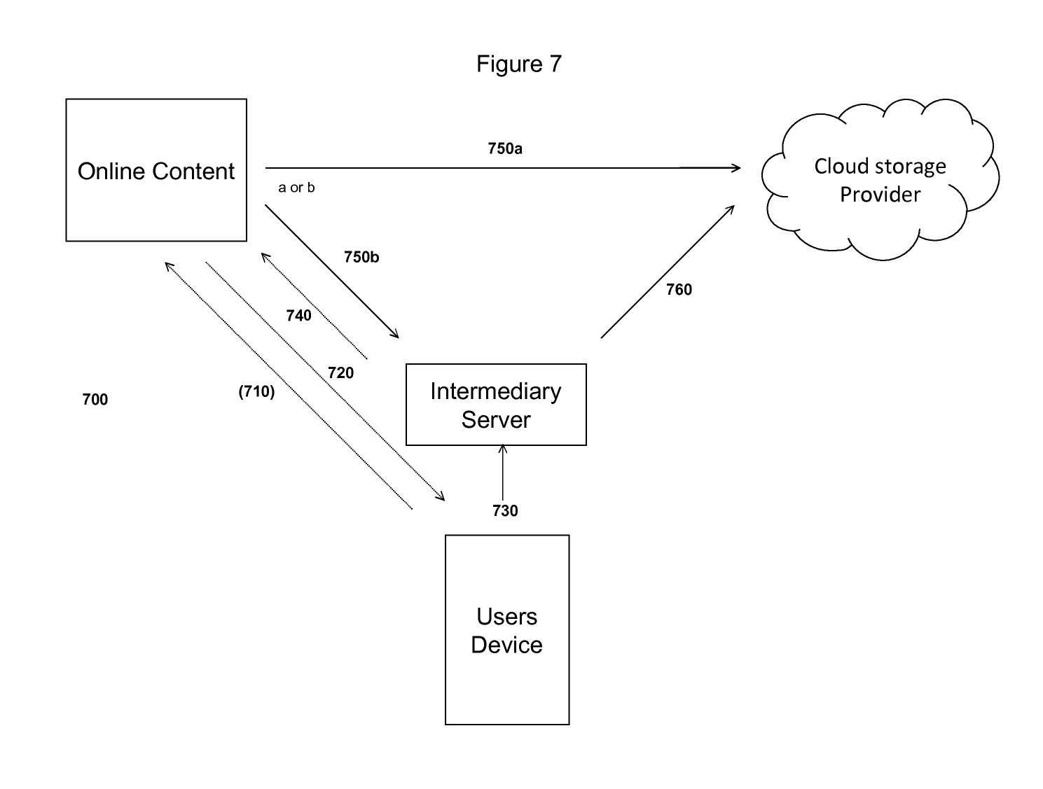

Referring now to FIG. 7, this alternate method features an intermediary server directing the data transfer to authenticated cloud storage. Step 710 is an optional step wherein the user may identify a requested file from an online content source, and initiate a download of the requested file to their device. The online content source seeks user acknowledgment to download the requested file 720, as discussed above with respect to step 520 shown in FIG. 5. The present invention calls on an intermediary server to handle the transfer to the authenticated cloud storage account of the user in step 730: sending a request from the user device to the intermediary server for the intermediary server to provide the online content source with credentials for authentication to either the intermediary server or the third storage position. The intermediary server provides the online content server with the URI of either the intermediary server or the third storage position of the user in step 740: sending the credentials for authentication and the intermediary server URI from either the intermediary server or the third storage position to the online content source. Thus the transfer of the requested file is handled in one of two ways. The online content server is either directed to transfer the requested file directly to the authenticated cloud storage account of the user 750a, or the online content server is directed to transfer the requested file to the intermediary server 750b where the intermediary server then transfers the requested file to the authenticated cloud storage account of the user 760.

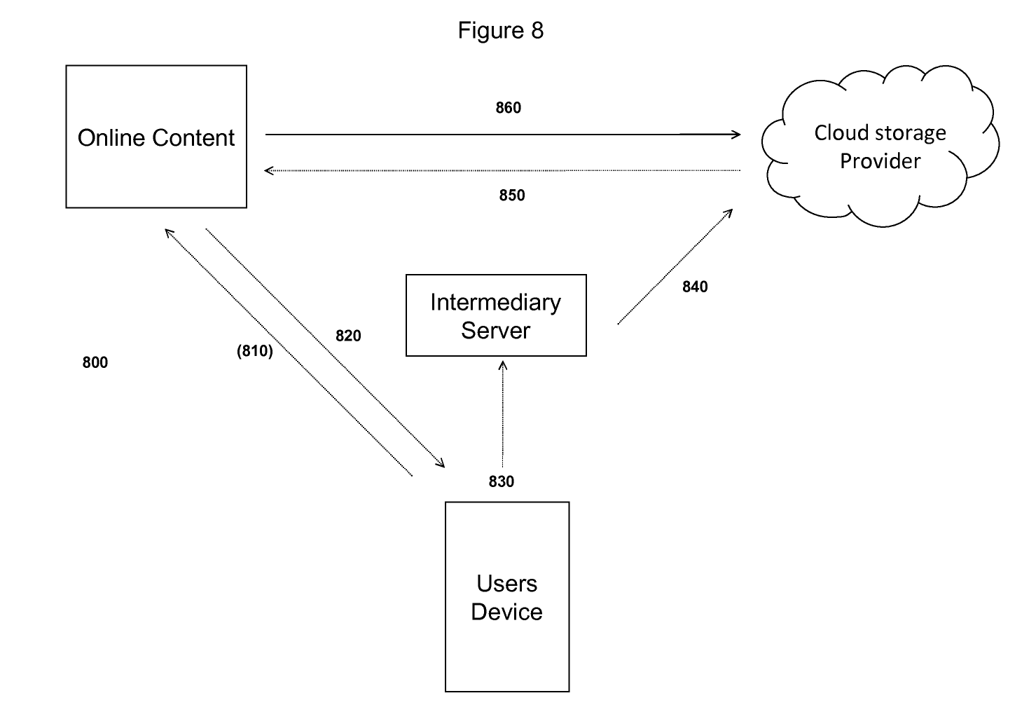

Referring now to FIG. 8, this alternate method features an intermediary server referring the authenticated cloud storage account of the user to the online content server of the requested file. Step 810 is an optional step wherein the user may identify a requested file from an online content source, and initiate a download of the requested file to their device, as discussed above. The online content source seeks user acknowledgment to download the requested file 820, also as discussed above. The present invention calls on an intermediary server 830 to submit credentials and URI of requested file to the cloud service account of the user in step 840: providing an online content source URI to an intermediary server. The authenticated cloud storage provider requests the requested file from the online content source in step 850. The requested file is transferred to the authenticated cloud storage account of the user 860.

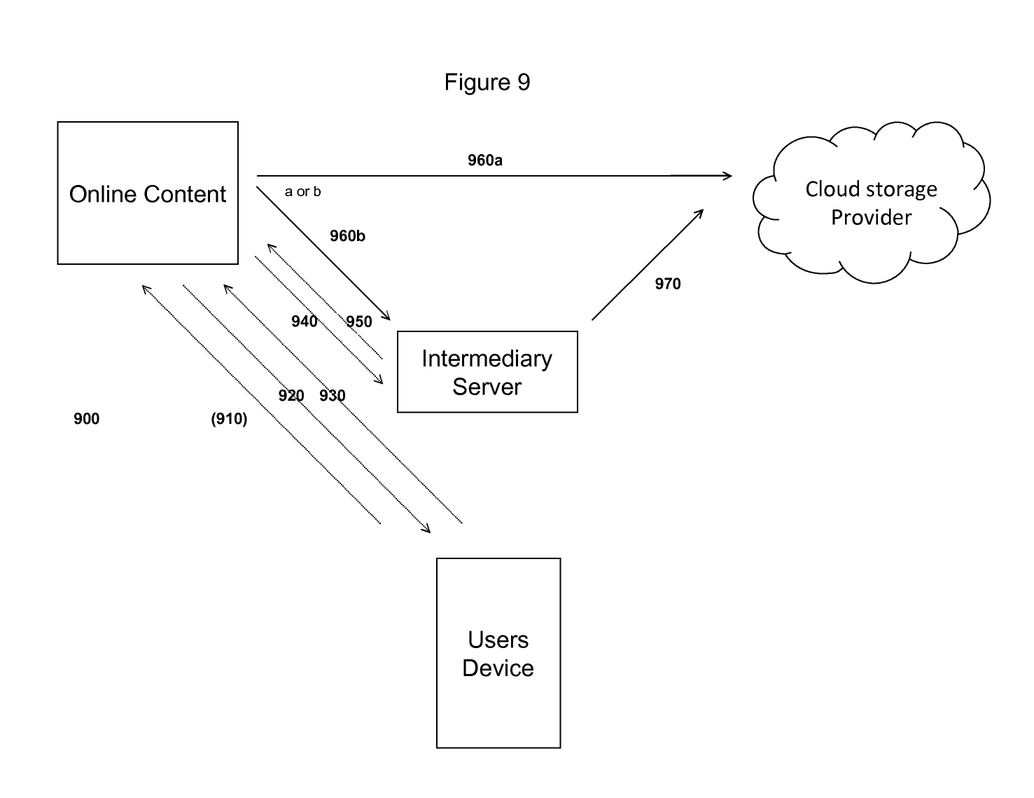

Referring now to FIG. 9, the user device refers the online content server to an intermediary server for data transmission routing. Step 910 is an optional step wherein the user may identify a requested file from an online content source, and initiate a download of the requested file to their device. The online content source seeks user acknowledgment to download the requested file in step 920: presenting the online content from the online content source to the user device. The present invention responds to the online content source server in step 930: providing the online content source with the intermediary server URI and credentials for authentication to the intermediary server from the user device. The online content source then contacts the intermediary server for instructions in step 940: providing the credentials for authentication from the online content source to the intermediary server. The intermediary server sends direction 950 to the online content server in one of two ways, as discussed above: The online content server is to transfer the requested file directly to the authenticated cloud storage account of the user 960a or to transfer the requested file to the intermediary server 960b which will relay the requested file and transfer it to the authenticated cloud storage account of the user 970.

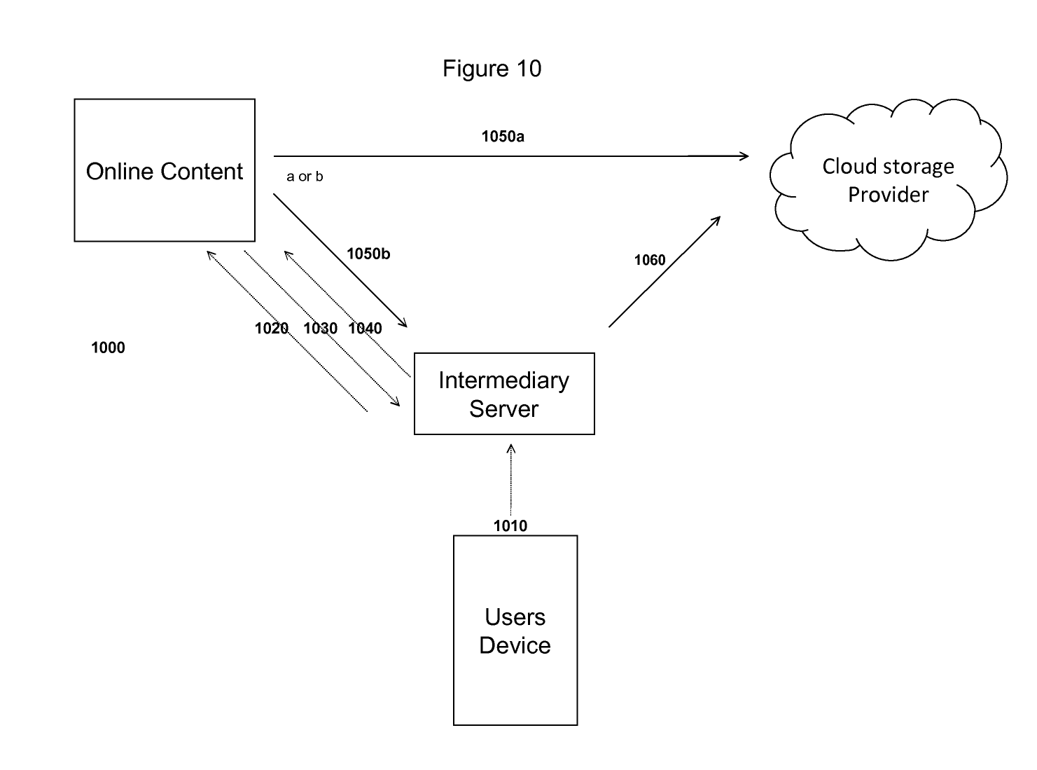

Referring now to FIG. 10, the user device connects to and uses an intermediary server as a proxy. All network connections that the user device makes passes through the intermediary server before reaching the user device in step 1010: of using the intermediary as a proxy for the user device such that there is no direct communication between the user device and the online content source or the third storage position. The user browses with the intermediary server. The user identifies the requested file 1020 through the intermediary service. The online content source of the requested file contacts the intermediary server for instructions for transferring the requested file in step 1030: receiving a request from the online content source to the intermediary server for confirmation of a request to download the online content. The intermediary server sends direction 1040 to the online content server in one of two ways: The online content server is to transfer the requested file directly to the authenticated cloud storage account of the user in step 1050a after providing a third storage position URI from the intermediary server to the online content source in confirmation. Alternatively, the online content server is to transfer the requested file to the intermediary server in step 1050b after providing an intermediary server URI from the intermediary server to the online content source in confirmation, which will relay the requested file and transfer it to the authenticated cloud storage account of the user 1060.

The advantages of the present invention include, without limitation, redirecting requested files to authenticated cloud storage reduces the costs of using the device. The device will not have to store requested files, as the files will be downloaded to authenticated storage. This will save storage space on the device, the processors and related device components will have to work less, incurring less energy consumption and general wear and tear on the device over all.

The present invention will likely yield faster download speeds as data can be transmitted faster over network to network connections where high bandwidth trunk lines will be utilized more often. The requested data will not flow over comparatively slower network connections to the user device, so there will likely be a faster transmission of data that the user will be able to access from their authenticated cloud storage.

The very action of downloading to authenticated cloud storage gives the user more flexibility in terms of where and when they can get work done. This opens up the ability for the user to be in a remote location, locate a requested file, download it to their authenticated cloud storage and then retrieve it and work with it as their ability to do so permits.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A computer-implemented method for bypassing a user device when downloading online content from an online content source to a third storage position, comprising the steps of:
receiving an indication of the online content to be downloaded;
directing the download to the third storage position; and
downloading the online content to the third storage position.

2. The method as claimed in claim 1, wherein said step of directing the download to the third storage position comprises providing the online source with a third storage position URI.

3. The method as claimed in claim 1, further comprising the steps of:
configuring the user device with credentials for authentication allowing access to the third storage position; and
transmitting the credentials for authentication to the third storage position.

4. The method as claimed 3:
wherein said step of transmitting the credentials for authentication comprises transmitting the credentials for authentication via a third storage position API; and
further comprising the step of loading the drive state of the third storage position API to prepare the third storage position to receive the online content.

5. The method as claimed in claim 1, wherein:
said step of receiving an indication of the online content to be downloaded comprises receiving an indication from the user device an indication of the online content to be downloaded and a user device URI; and
said step of directing the download to the third storage position comprises replacing the user device URI with a third storage position URI to redirect the download from the user device to the third storage position.

6. The method as claimed in claim 1, further comprising the step of sending an acknowledgement to the user device when said step of downloading the online content to the third storage position is completed.

7. The method as claimed in claim 1, wherein said step of receiving an indication of the online content to be downloaded comprises receiving an indication from the user device of the online content to be downloaded.

8. The method as claimed in claim 1, further comprising the steps of:
receiving a request from the online content source for confirmation of a request to download the online content to the third storage position; and
confirming the request to download the online content to the third storage position by providing a third storage position URI from the user device to the online content source.

9. The method as claimed in claim 1, further comprising the step of receiving from the user device an indication of the third storage position to which the user has access and to which the user desires the online content to be downloaded.

10. The method as claimed in claim 1, further comprising the steps of:
receiving a request from the online content source for the third storage position; and
providing the third storage position to the online content source.

11. The method as claimed in claim 10, wherein said step of providing the third storage position comprises the steps of:
receiving a default third storage position from the user device; and
providing the default third storage position to the online content source.

12. The method as claimed in claim 10, wherein said step of providing the third storage position comprises the steps of:
receiving a selected third storage position from the user device; and
providing the selected third storage position to the online content source.

13. The method as claimed in claim 1, wherein said step of receiving an indication of the online content to be downloaded comprises the steps of:
providing the third storage position with a URI of the online content desired to be downloaded; and
sending a request from the third storage position to the online content source for a transmission of the online content desired to be downloaded.

14. The method as claimed in claim 13, further comprising the step of authenticating the user device to the third storage position.

15. The method as claimed in claim 1, wherein said step of downloading the online content to the third storage position comprises the steps of:
downloading the online content from the online content source to an intermediary server; and
downloading the online content from the intermediary server to the third storage position.

16. The method as claimed in claim 15, further comprising the steps of:
sending a request from the user device to the intermediary server for the intermediary server to provide the online content source with credentials for authentication to the intermediary server; and
sending the credentials for authentication and the intermediary server URI from the intermediary server to the online content source.

17. The method as claimed in claim 15, further comprising the steps of:
presenting the online content from the online content source to the user device;
providing the online content source with the intermediary server URI and credentials for authentication to the intermediary server from the user device; and
providing the credentials for authentication from the online content source to the intermediary server.

18. The method as claimed in claim 15, further comprising the step of using the intermediary as a proxy for the user device such that there is no direct communication between the user device and the online content source or the third storage position, wherein:
said step of receiving an indication of the online content to be downloaded comprises sending an indication of the selected online content from the user device to the intermediary server and then to the online content source; and
said step of directing the download to the third storage position comprises the steps of:
receiving a request from the online content source to the intermediary server for confirmation of a request to download the online content; and
providing an intermediary server URI from the intermediary server to the online content source in confirmation.

19. The method as claimed in claim 1, further comprising the steps of:
sending a request from the user device to an intermediary server for the intermediary server to provide the online content source with credentials for authentication to the third storage position; and
sending the credentials for authentication and the third storage position URI from the intermediary server to the online content source.

20. The method as claimed in claim 1, further comprising the steps of:
sending a request from the user device to an intermediary server for the intermediary server to provide the third storage position with credentials for authentication to the third storage position; and
sending the credentials for authentication and the third storage position URI from the third storage position to the online content source.

21. The method as claimed in claim 1, further comprising the steps of:
presenting the online content from the online content source to the user device;
providing the online content source with an intermediary server URI and credentials for authentication to the intermediary server from the user device;
providing the credentials for authentication from the online content source to the intermediary server; and
providing the online content source with a third storage position URI.

22. The method as claimed in claim 1, further comprising the steps of:
providing an online content source URI to an intermediary server;
providing the online content source URI from the intermediary server to the third storage position; and
receiving a request from the third storage position to the online content source to transmit the online content.

23. The method as claimed in claim 1, further comprising the step of using an intermediary server as a proxy for the user device such that there is no direct communication between the user device and the online content source or the third storage position, wherein:
said step of receiving an indication of the online content to be downloaded comprises sending an indication of the selected online content from the user device to the intermediary server and then to the online content source; and
said step of directing the download to the third storage position comprises the steps of:
receiving a request from the online content source to the intermediary server for confirmation of a request to download the online content; and
providing a third storage position URI from the intermediary server to the online content source in confirmation.

24. The method as claimed in claim 1, wherein the third storage position is a cloud storage provider.

25. A system for bypassing a user device when downloading online content from an online content source to a third storage position, said system comprising at least one user device comprising a non-transitory computer storage medium encoded with computer software and a data processing apparatus; at least one online content source of the online content; at least one third storage position; and an internet connection between said at least one user device, said at least one online content source, and said at least one third storage position; wherein said computer software comprises instructions that, when executed by said data processing apparatus cause said system to perform steps comprising:
receiving an indication of the online content to be downloaded;
directing the download to the third storage position; and
downloading the online content to the third storage position.

26. The system as claimed in claim 25, wherein said step of directing the download to the third storage position comprises providing the online source with a third storage position URI.

27. The system as claimed in claim 25, wherein when said computer software is executed, said data processing apparatus further causes said system to perform the steps of:
configuring the user device with credentials for authentication allowing access to the third storage position; and
transmitting the credentials for authentication to the third storage position.

28. The system as claimed 27:
wherein said step of transmitting the credentials for authentication comprises transmitting the credentials for authentication via a third storage position API; and
wherein when said computer software is executed, said data processing apparatus further causes said system to perform the step of loading the drive state of the third storage position API to prepare the third storage position to receive the online content.

29. The system as claimed in claim 25, wherein:
said step of receiving an indication of the online content to be downloaded comprises receiving an indication from the user device an indication of the online content to be downloaded and a user device URI; and
said step of directing the download to the third storage position comprises replacing the user device URI with a third storage position URI to redirect the download from the user device to the third storage position.

30. The system as claimed in claim 25, wherein when said computer software is executed, said data processing apparatus further causes said system to perform the step of sending an acknowledgement to the user device when said step of downloading the online content to the third storage position is completed.

31. The system as claimed in claim 25, wherein said step of receiving an indication of the online content to be downloaded comprises receiving an indication from the user device of the online content to be downloaded.

32. The system as claimed in claim 25, wherein when said computer software is executed, said data processing apparatus further causes said system to perform the steps of:
receiving a request from the online content source for confirmation of a request to download the online content to the third storage position; and
confirming the request to download the online content to the third storage position by providing a third storage position URI from the user device to the online content source.

33. The system as claimed in claim 25, wherein when said computer software is executed, said data processing apparatus further causes said system to perform the step of receiving from the user device an indication of the third storage position to which the user has access and to which the user desires the online content to be downloaded.

34. The system as claimed in claim 25, wherein when said computer software is executed, said data processing apparatus further causes said system to perform the steps of:
receiving a request from the online content source for the third storage position; and
providing the third storage position to the online content source.

35. The method as claimed in claim 34, wherein said step of providing the third storage position comprises the steps of:
receiving a default third storage position from the user device; and
providing the default third storage position to the online content source.

36. The system as claimed in claim 34, wherein said step of providing the third storage position comprises the steps of:
receiving a selected third storage position from the user device; and
providing the selected third storage position to the online content source.

37. The system as claimed in claim 25, wherein said step of receiving an indication of the online content to be downloaded comprises the steps of:
providing the third storage position with a URI of the online content desired to be downloaded; and
sending a request from the third storage position to the online content source for a transmission of the online content desired to be downloaded.

38. The system as claimed in claim 37, wherein when said computer software is executed, said data processing apparatus further causes said system to perform the step of authenticating the user device to the third storage position.

39. The system as claimed in claim 25, wherein said step of downloading the online content to the third storage position comprises the steps of:
downloading the online content from the online content source to an intermediary server; and
downloading the online content from the intermediary server to the third storage position.

40. The system as claimed in claim 39, wherein when said computer software is executed, said data processing apparatus further causes said system to perform the steps of:
sending a request from the user device to the intermediary server for the intermediary server to provide the online content source with credentials for authentication to the intermediary server; and
sending the credentials for authentication and the intermediary server URI from the intermediary server to the online content source.

41. The system as claimed in claim 39, wherein when said computer software is executed, said data processing apparatus further causes said system to perform the steps of:
presenting the online content from the online content source to the user device;
providing the online content source with the intermediary server URI and credentials for authentication to the intermediary server from the user device; and
providing the credentials for authentication from the online content source to the intermediary server.

42. The system as claimed in claim 39, wherein when said computer software is executed, said data processing apparatus further causes said system to perform the step of using the intermediary as a proxy for the user device such that there is no direct communication between the user device and the online content source or the third storage position, wherein:
said step of receiving an indication of the online content to be downloaded comprises sending an indication of the selected online content from the user device to the intermediary server and then to the online content source; and
said step of directing the download to the third storage position comprises the steps of:
receiving a request from the online content source to the intermediary server for confirmation of a request to download the online content; and
providing an intermediary server URI from the intermediary server to the online content source in confirmation.

43. The system as claimed in claim 25, wherein when said computer software is executed, said data processing apparatus further causes said system to perform the steps of:
sending a request from the user device to an intermediary server for the intermediary server to provide the online content source with credentials for authentication to the third storage position; and
sending the credentials for authentication and the third storage position URI from the intermediary server to the online content source.

44. The system as claimed in claim 25, wherein when said computer software is executed, said data processing apparatus further causes said system to perform the steps of:
sending a request from the user device to an intermediary server for the intermediary server to provide the third storage position with credentials for authentication to the third storage position; and
sending the credentials for authentication and the third storage position URI from the third storage position to the online content source.

45. The system as claimed in claim 25, wherein when said computer software is executed, said data processing apparatus further causes said system to perform the steps of:
presenting the online content from the online content source to the user device;
providing the online content source with an intermediary server URI and credentials for authentication to the intermediary server from the user device;
providing the credentials for authentication from the online content source to the intermediary server; and
providing the online content source with a third storage position URI.

46. The system as claimed in claim 25, wherein when said computer software is executed, said data processing apparatus further causes said system to perform the steps of:
providing an online content source URI to an intermediary server;
providing the online content source URI from the intermediary server to the third storage position; and
receiving a request from the third storage position to the online content source to transmit the online content.

47. The system as claimed in claim 25, wherein when said computer software is executed, said data processing apparatus further causes said system to perform the step of using an intermediary server as a proxy for the user device such that there is no direct communication between the user device and the online content source or the third storage position, wherein:
said step of receiving an indication of the online content to be downloaded comprises sending an indication of the selected online content from the user device to the intermediary server and then to the online content source; and
said step of directing the download to the third storage position comprises the steps of:
receiving a request from the online content source to the intermediary server for confirmation of a request to download the online content; and
providing a third storage position URI from the intermediary server to the online content source in confirmation.

48. The system as claimed in claim 25, wherein the third storage position is a cloud storage provider.
